(19) United States
(12) Patent Application Publication
(10) Pub. No.: US 2013/0090082 A1
(43) Pub. Date: Apr. 11, 2013

(54) APPARATUS AND METHOD FOR PROVIDING EMERGENCY CALL IN MOBILE COMMUNICATION SYSTEM

(71) Applicant: Samsung Electronics Co., Ltd, Gyeonggi-do (KR)

(72) Inventors: Han-Na Lim, Seoul (KR); Song-Yean Cho, Seoul (KR); Beom-Sik Bae, Gyeonggi-do (KR); Jung-Je Son, Gyeonggi-do (KR); Sang-Soo Jeong, Gyeonggi-do (KR)

(73) Assignee: Samsung Electronics Co., Ltd., Gyeonggi-do (KR)

(21) Appl. No.: 13/648,898

(22) Filed: Oct. 10, 2012

(30) Foreign Application Priority Data
Oct. 10, 2011 (KR) 10-2011-0103316

(51) Int. Cl. H04W 4/22

(52) U.S. Cl. 455/404.1

(57) ABSTRACT

An apparatus and method for providing an emergency call in a mobile communication system are provided. In the method, a User Equipment (UE) transmits the first message including the first information as information indicating that the UE requests an emergency call and a Non Voice Emergency Service (NOVES) to the network entity, and receives the second message including the second information as information indicating whether at least one Public Land Mobile Network (PLMN) supports the NOVES, and media types which at least one access network included in the at least one PLMN supports from the network entity.

### CROSS-REFERENCE TO RELATED APPLICATION(S) AND CLAIM OF PRIORITY

The present application is related to and claims the benefit under 35 U.S.C. §119(a) of a Korean Patent Application No. 10-2011-0103316, filed on Oct. 10, 2011, in the Korean Intellectual Property Office, the entire disclosure of which is hereby incorporated by reference.

### TECHNICAL FIELD OF THE INVENTION

The present disclosure relates to an apparatus and method for providing an emergency call in a mobile communication system.

### BACKGROUND OF THE INVENTION

A mobile communication conventionally provides a voice-type emergency call. However, there is a need for a service providing a non voice type-emergency call as a packet communication system has been evolved, and smart phones have been commonly used. So, Non Voice Emergency Service (NOVES) has been proposed to satisfy the need. The NOVES provides a non voice type-emergency call, i.e., a NOVES call which is a media type-emergency call, for example, such as a video streaming type—emergency call and a text-type emergency call.

### SUMMARY OF THE INVENTION

To address the above-discussed deficiencies of the prior art, it is a primary object to provide an apparatus and method for providing an emergency call in a mobile communication system.

Another aspect of the present disclosure is to provide an emergency call provision apparatus and method for notifying whether a serving PLMN supports a NOVES in a mobile communication system.

Further another aspect of the present disclosure is to provide an emergency call provision apparatus and method for notifying media types supported in each of a plurality of access networks included in a serving PLMN in a mobile communication system.

According to one aspect of the present disclosure, there is a User Equipment (UE) provided in a mobile communication system. The UE includes a transmitter for transmitting the first message including the first information as information indicating that the UE requests a Non Voice Emergency Service (NOVES) to the network entity; and a receiver for receiving the second message including the second information as information indicating at least one Public Land Mobile Network (PLMN) which supports the NOVES, and media types which at least one access network included in the at least one PLMN supports from the other entity.

According to another aspect of the present disclosure, there is provided an emergency call provision entity in a mobile communication system. The emergency call provision entity includes a receiver for receiving the first message including the first information indicating that a User Equipment (UE) requests an emergency call and a Non Voice Emergency Service (NOVES) from the UE; and a transmitter for transmitting the second message including the second information indicating at least one Public Land Mobile Network (PLMN) which supports the NOVES, and media types which at least one access network included in the at least one PLMN supports to the UE.

According to further another aspect of the present disclosure, there is provided a method for making an emergency call at a User Equipment (UE) in a mobile communication system. The method includes the steps of transmitting the first message including the first information as information indicating that the UE requests an emergency call and a Non Voice Emergency Service (NOVES) to the network entity; and receiving the second message including the second information as information indicating whether at least one Public Land Mobile Network (PLMN) supports the NOVES, and media types which at least one access network included in the at least one PLMN supports from the network entity.

According to still another aspect of the present disclosure, there is provided a method for providing an emergency call in a mobile communication system. The method includes the steps of receiving the first message including the first information indicating that a User Equipment (UE) requests an emergency call and a Non Voice Emergency Service (NOVES) from the UE; and transmitting the second message including the second information as information indicating at least one Public Land Mobile Network (PLMN) which supports the NOVES, and media types which at least one access network included in the at least one PLMN supports to the UE.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or: the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 schematically illustrates an Internet Protocol Multimedia Subsystem (IMS) according to one embodiment of the present disclosure;

FIG. 2 is a signal flow diagram schematically illustrating an emergency call provision process for notifying whether a serving PLMN supports a NOVES, and media types supported in each of access networks operated by the serving PLMN in an IMS according to the first exemplary embodiment of the present disclosure;

FIG. 3 is a flowchart schematically illustrating an operation of a UE illustrated in FIG. 2;

FIG. 4 is a flowchart schematically illustrating an operation of a Proxy-Call Session Control Function (P-CSCF) entity illustrated in FIG. 2;

FIG. 5 is a signal flow diagram schematically illustrating an emergency call provision process for notifying PLMNs which support a NOVES, and media types supported in each of access networks operated by the PLMNs in an IMS according to the second exemplary embodiment of the present disclosure;

FIG. 6 is a flowchart schematically illustrating an operation of a UE illustrated in FIG. 5;

FIG. 7 is a flowchart schematically illustrating an operation of an ANDSF entity illustrated in FIG. 5;

FIG. 8 is a signal flow diagram schematically illustrating an emergency call provision process for notifying whether a serving PLMN supports a NOVES, and media types which are supported in each of access networks operated by the serving PLMN based on an access network which a UE can use in an IMS according to the third exemplary embodiment of the present disclosure;

FIG. 9 is a flowchart schematically illustrating an operation of a UE illustrated in FIG. 8;

FIG. 10 is a flowchart schematically illustrating an operation of an ANDSF entity illustrated in FIG. 8;

FIG. 11 is a block diagram schematically illustrating an internal structure of a UE in an IMS according to exemplary embodiments of the present disclosure;

FIG. 12 is a block diagram schematically illustrating an internal structure of a P-CSCF entity in an IMS according to exemplary embodiments of the present disclosure; and

FIG. 13 is a block diagram schematically illustrating an internal structure of an ANDSF entity in an IMS according to exemplary embodiments of the present disclosure.

Throughout the drawings, the same drawing reference numerals will be understood to refer to the same elements, features and structures.

### DETAILED DESCRIPTION OF THE INVENTION

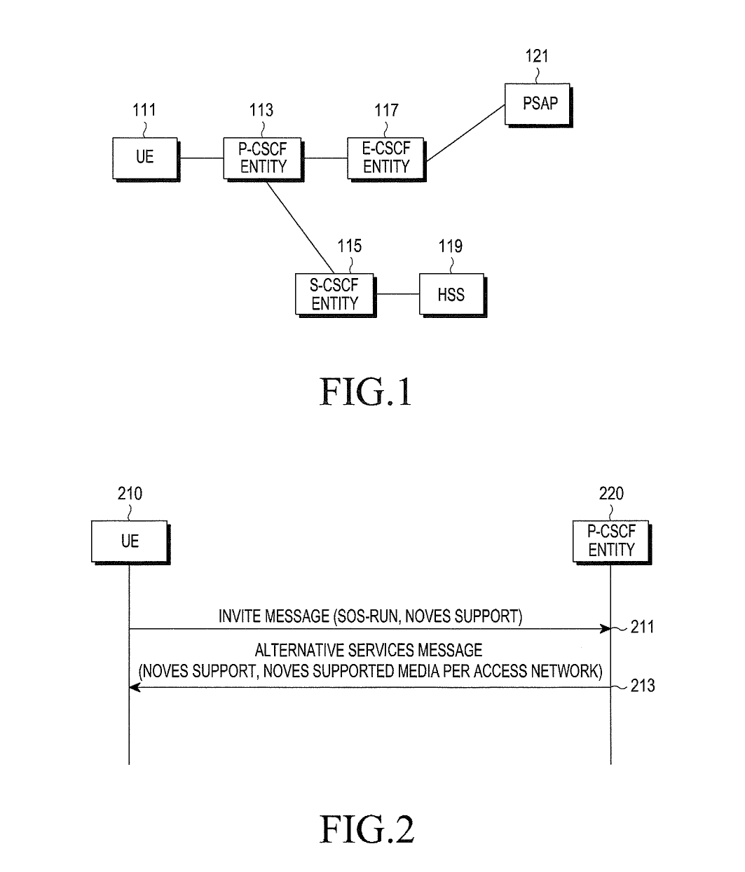

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Preferred embodiments of the present invention will now be described in detail with reference to the accompanying drawings. In the following description, specific details such as detailed configuration and components are merely provided to assist the overall understanding of exemplary embodiments according to the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

An exemplary embodiment according to the present disclosure proposes an apparatus and method for providing an emergency call in a mobile communication system. Another exemplary embodiment according to the present disclosure proposes an emergency call provision apparatus and method for notifying whether a serving Public Land Mobile Network (PLMN) supports a Non Voice Emergency Service (NOVES) in a mobile communication system. Further another exemplary embodiment according to the present disclosure proposes an emergency call provision apparatus and method for notifying media types supported in each of a plurality of access networks included in a serving PLMN in a mobile communication system.

Exemplary embodiments according to the present disclosure will be described below in relation to a mobile communication system, for example, an Internet Protocol (IP) Multimedia Subsystem (IMS). However, it will be understood by those of ordinary skill in the art that the mobile communication system can be any one of an Evolved Packet System (EPS), a Long-Term Evolution (LTE) mobile communication system, and an Institute of Electrical and Electronics Engineers (IEEE) 802.16m mobile communication system as well as the IMS.

FIG. 1 schematically illustrates an IMS according to one embodiment according to the present disclosure. The IMS includes a User Equipment (UE) 111, a Proxy-Call Session Control Function (CSCF) (P-CSCF) entity 113, a Serving-CSCF (S-CSCF) entity, an Emergency-CSCF (E-CSCF) entity 117, a Home Subscriber Server (HSS) entity 119, and a Public Safety Answering Point (PSAP) 121.

The P-CSCF entity 113 is the entity which the UE 111 firstly and lastly accesses on an incoming call and an outgoing call, and the S-CSCF entity 115 controls a normal call. The E-CSCF entity 117 controls an emergency call, searches the nearest PSPA from the E-CSCF entity 117 upon receiving an emergency call request from the P-CSCF entity 113, and routes an emergency call to the searched PSAP, i.e., the PSAP 121.

The P-CSCF entity 113, the E-CSCF entity 117 and the PSAP 121 should be located in a local network in which the UE 111 is located for the IMS to provide an emergency call, and the S-CSCF entity 115 is located in a home network in which the UE 111 joins. The HSS 119 stores join information on UEs, and the join information on the UEs is used for the S-CSCF entity 115 to control calls of the UEs.

The UE 111 transmits an INVITE message including a sos-urn as a parameter indicating an emergency call to the P-CSCF entity 113 in order to request an emergency call. The P-CSCF entity 113 notices that the UE 111 requests the emergency call by detecting the sos-urn included in the INVITE message, and transmits a call request to the E-CSCF entity 117. The E-CSCF entity 117 routes the emergency call to the nearest PSAP, i.e., the PSAP 121 using location information of the UE 111, a policy of a service provider, and the like.

FIG. 2 is a signal flow diagram schematically illustrating an emergency call provision process for notifying whether a serving PLMN supports a NOVES, and media types which are supported in each of access networks operated by the serving PLMN in an IMS according to the first exemplary embodiment according to the present disclosure.

A UE 210 transmits an INVITE message to a P-CSCF entity 220 in order to request an emergency call (step 211). The INVITE message includes a sos-urn and a NOVES support. The NOVES support included in the INVITE message is a parameter indicating that the UE 210 requests a NOVES.

After receiving the INVITE message from the UE 210, the P-CSCF entity 220 can notice that the UE 210 requests the emergency call and the NOVES by detecting the sos-urn and the NOVES support included in the INVITE message.

So, the P-CSCF entity 220 detects whether a serving PLMN supports the NOVES, and media types which each of access networks operated by the serving PLMN supports if the serving PLMN supports the NOVES. The P-CSCF entity 220 transmits an Alternative services message as a response massage to the INVITE message to the UE 210 (step 213). The Alternative services message includes a NOVES support and a NOVES supported media per access network. The NOVES support included in the Alternative services message is a parameter indicating whether the serving PLMN supports the NOVES, and the NOVES supported media per access network is a parameter indicating media types which each of access networks operated by the serving PLMN supports.

As described above, the NOVES support can be included in the INVITE message or the Alternative services message. If the NOVES support is included in the INVITE message, the NOVES support can be interpreted as a parameter indicating that a UE transmitting the INVITE message requests a NOVES. If the NOVES support is included in the Alternative services message, the NOVES support can be interpreted as a parameter indicating whether a serving PLMN supports the NOVES.

In FIG. 2, the Alternative services message includes the NOVES support and the NOVES supported media per access network, however, it will be understood by those of ordinary skill in the art that the Alternative services message cannot include the NOVES supported media per access network if the serving PLMN does not support the NOVES.

While a parameter indicating whether a serving PLMN supports a NOVES and a parameter indicating media types supported in each of access networks operated by the serving PLMN are implemented in FIG. 2 as separate parameters, i.e., a NOVES support and a NOVES supported media per access network, it is to be understood that this is for merely convenience of description. In other words, the NOVES support and the NOVES supported media per access network can be implemented as a single parameter.

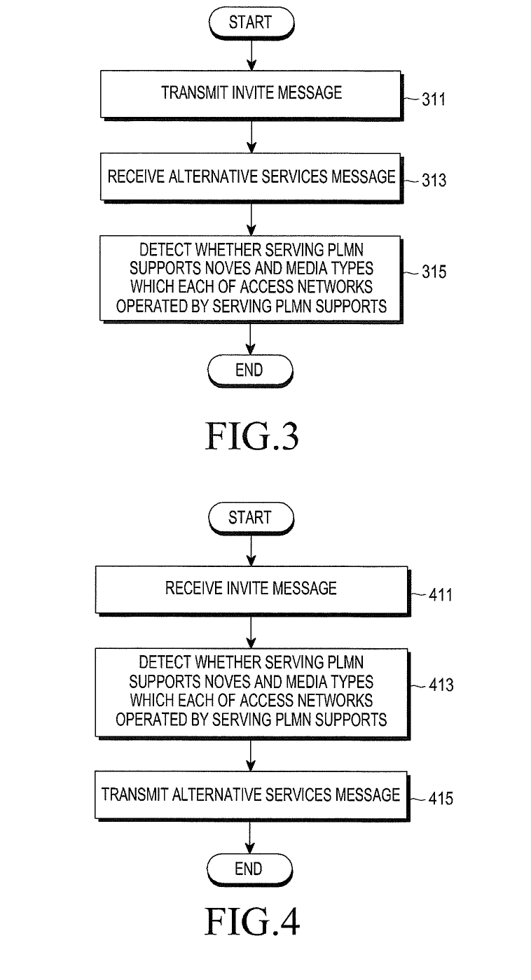

FIG. 3 is a flowchart schematically illustrating an operation of a UE 210 illustrated in FIG. 2. A UE 210 transmits at step 311 an INVITE message to a P-CSCF entity 220 in order to request an emergency call. The INVITE message includes a sos-urn and a NOVES support. The UE 210 receives at step 313 an Alternative services message as a response message to the INVITE message from the P-CSCF entity 220. The Alternative services message includes a NOVES support and a NOVES supported media per access network.

The UE 210 notices at step 315 whether a serving PLMN supports a NOVES and media types which each of access networks operated by the serving PLMN supports by detecting the NOVES support and the NOVES supported media per access network included in the Alternative services message.

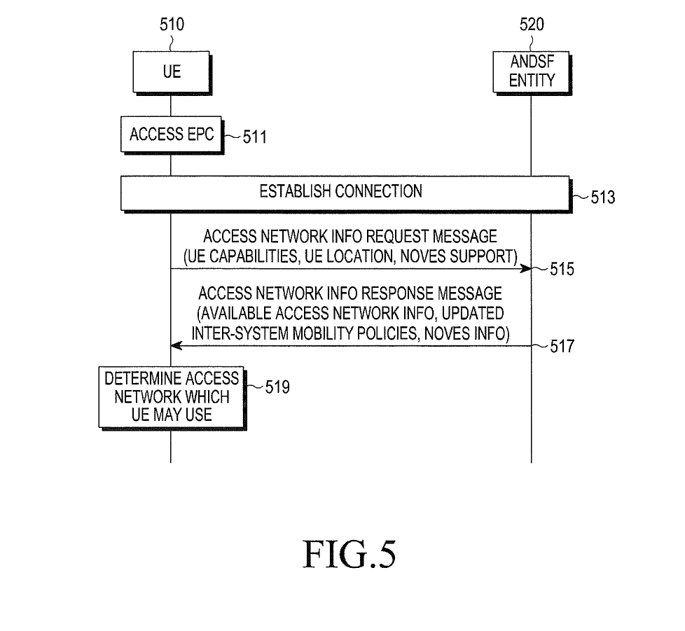

FIG. 4 is a flowchart schematically illustrating an operation of a P-CSCF entity 220 illustrated in FIG. 2. A P-CSCF entity 220 receives at step 411 an INVITE message from a UE 210. The INVITE message includes a sos-urn and a NOVES support. The P-CSCF entity 220 detects at step 413 that the UE 210 requests a NOVES by detecting the NOVES support included in the INVITE message, so notices whether a serving PLMN supports the NOVES and media types supported in each of access networks operated by the serving PLMN. The P-CSCF entity 220 transmits at step 415 an Alternative services message including a NOVES support indicating whether the serving PLMN supports the NOVES and a NOVES supported media per access network indicating the media types supported in the each of the access networks operated in the serving PLMN to the UE 210.

In the first exemplary embodiment according to the present disclosure, as described in FIGS. 2 to 4, a UE notices whether a serving PLMN supports a NOVES and media types supported in each of access networks operated by the serving PLMN from a P-CSCF entity.

FIG. 5 is a signal flow diagram schematically illustrating an emergency call provision process for notifying whether PLMNs support a NOVES, and media types supported in each of access networks operated by the PLMNs in an IMS according to the second exemplary embodiment according to the present disclosure. A UE 510 accesses an Evolved Packet Core (EPC) through one of a Universal Terrestrial Radio Access Network (UTRAN), an Evolved Universal Terrestrial Radio Access Network (E-UTRAN), a World Interoperability for Microwave Access (WiMAX), and the like (step 511). The UE 510 accesses the EPC and establishes a connection with an Access Network Discovery and Selection Function (ANDSF) entity 520 (step 513). The UE 510 transmits an Access Network Info Request message to the ANDSF entity 520 after establishing the connection with the ANDSF entity 520 (step 515). The Access Network Info Request message includes a UE Capabilities as a parameter indicating an access network supported by the UE 510, a UE Location as a parameter indicating information related to a location of the UE 510 such as a cell Identifier (ID) of a cell in which the UE 510 is located or Global Positioning System (GPS) information of the UE 510, and a NOVES support as a parameter indicating that the UE 510 requests a NOVES.

After receiving the Access Network Info Request message from the UE 510, the ANDSF entity 520 detects the NOVES support included in the Access Network Info Request message, and NOVES information depending on detecting the NOVES support. The ANDSF entity 520 transmits an Access Network Info Response message as a response message to the Access Network Info Request message to the UE 510 (step 517). The Access Network Info Response message includes an Available Access Network Info as a parameter indicating information on an access network which the UE can use at a current location, a updated Inter-system Mobility Policies as a parameter indicating a service provider policy related to change of an access network, and a NOVES info indicating the detected NOVES information. In FIG. 5, it will be assumed that access networks which the UE can use at the current location are an LTE and a Wireless Local Area Network (W LAN).

The NOVES info can be implemented in the form of a table such as an exemplary Table 1.

TABLE 1

| List | PLMN | Access Network | media | media | media |
|---|---|---|---|---|---|
| 1 | PLMN1 | LTE | Voice | Text | |
| 2 | PLMN1 | WCDMA | Voice | | |
| 3 | PLMN1 | WLAN | Voice | Video | Text |
| 4 | PLMN2 | WLAN | Video | Text | |
| 5 | PLMN2 | WCDMA | Voice | | |

In Table 1, the NOVES info includes PLMN information indicating a PLMN ID(s) of a PLMN(s) supporting a NOVES, access network information indicating an access network(s) which supports the NOVES in the PLMN(s) supporting the NOVES, and media information indicating a media type(s) which the PLMN(s) and the access network(s) support.

After receiving the Access Network Info Response message from the ANDSF entity 520, the UE 510 determines an access network which the UE 510 can use based on parameters, specially the NOVES info, included in the Access Network Info Response message. Finally, the UE detects PLMNs which support a NOVES, and media types which each of access networks operated by the PLMNs supports from the NOVES info included in the Access Network Info Response message.

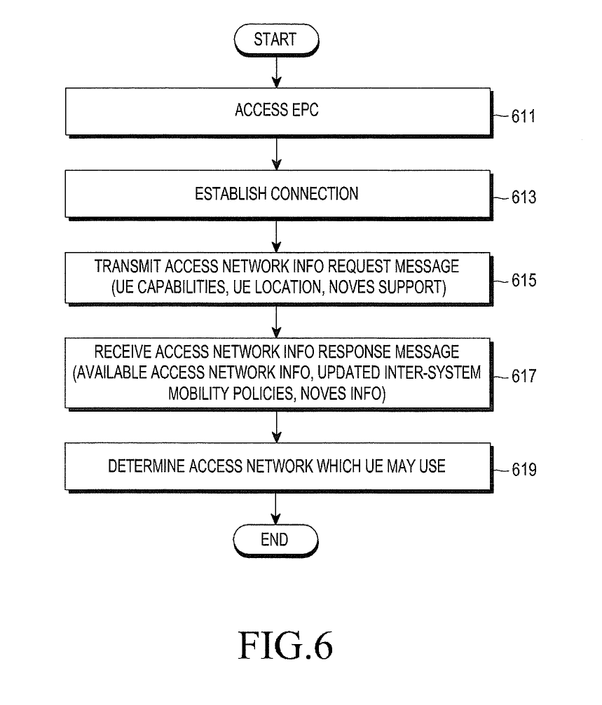

FIG. 6 is a flowchart schematically illustrating an operation of a UE 510 illustrated in FIG. 5. A UE 510 accesses at step 611 an EPC through one of a UTRAN, an E-UTRAN and a WiMAX. The UE 510 establishes at step 613 a connection with an ANDSF entity 520. The UE 510 transmits at step 615 an Access Network Info Request message to the ANDSF entity 520. The Access Network Info Request message includes a UE Capabilities, a UE Location and a NOVES support.

The UE 510 receives at step 617 an Access Network Info Response message as a response message to the Access Network Info Request message from the ANDSF entity 520. The Access Network Info Response message includes an Available Access Network Info, a updated Inter-system Mobility Policies and a NOVES info.

The UE 510 determines at step 619 an access network which the UE 510 will use based on parameters, specially a NOVES info included in the Access Network Info Response message.

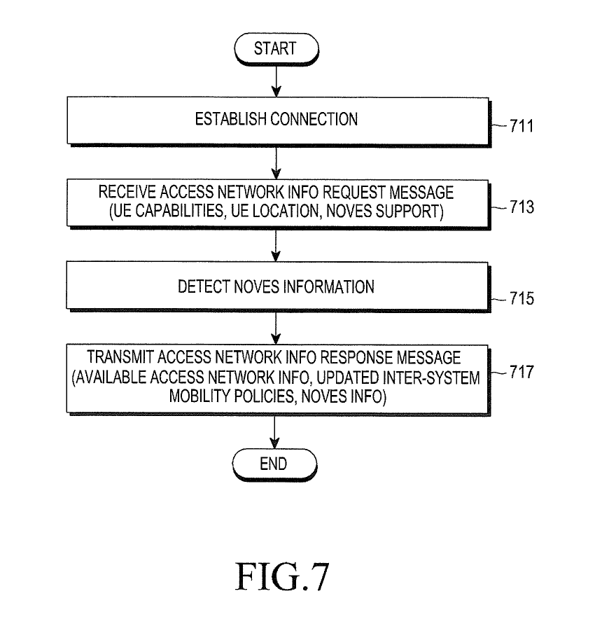

FIG. 7 is a flowchart schematically illustrating an operation of an ANDSF entity 520 illustrated in FIG. 5. An ANDSF entity 520 establishes at step 711 a connection with a UE 510. The ANDSF entity 520 receives at step 713 an Access Network Info Request message from the UE 510. The Access Network Info Request message includes a UE Capabilities, a UE Location and a NOVES support.

The ANDSF entity 520 notices at step 715 NOVES information by detecting the NOVES support included in the Access Network Info Request message. The ANDSF entity 520 transmits at step 717 an Access Network Info Response message as a response message to the Access Network Info Request message to the UE 510. The Access Network Info Response message includes an Available Access Network Info, a updated Inter-system Mobility Policies and a NOVES info.

In the second exemplary embodiment of the present disclosure, as described in FIGS. 5 to 7, a UE detects whether a PLMN(s) supports a NOVES and media types supported in each of access networks operated by the PLMN(s) from an ANDSF entity.

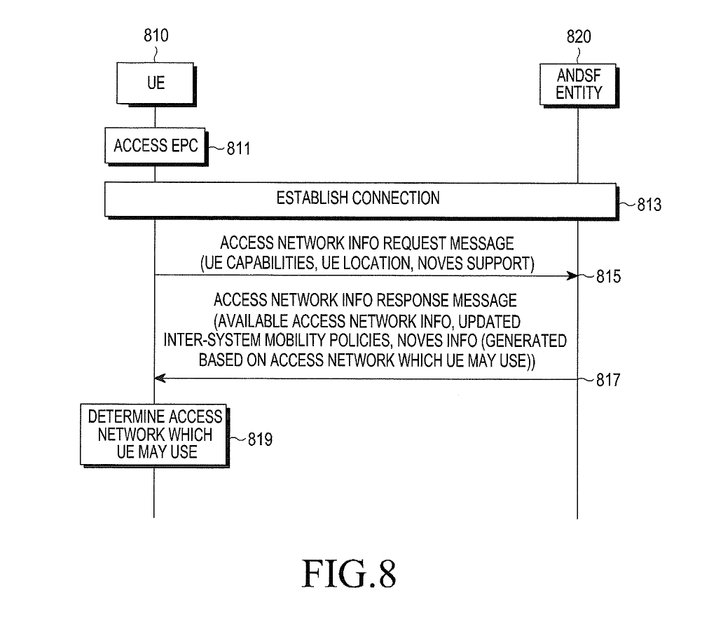

In the second exemplary embodiment of the present disclosure, as described in FIGS. 5 to 7, an ANDSF entity transmits a NOVES info including information related to an access network, not an LTE and a WLAN, i.e., a Wideband Code Division Multiple Access (WCDMA) to a UE even if access networks which the UE can use at a current location are the LTE and the WLAN. That is, information corresponding to the List 1 and the List 5 shown in the Table 1 is transmitted to the UE even though the information corresponding to the List 1 and the List 5 of the Table 1 is unnecessary for the UE. So, the third exemplary embodiment according to the present disclosure proposes an emergency call provision process for notifying whether a serving PLMN supports a NOVES, and media types supported in each of access networks operated by the serving PLMN based on an access network which a UE can use, and will be described below with reference to FIG. 8.

FIG. 8 is a signal flow diagram schematically illustrating an emergency call provision process for notifying whether a serving PLMN supports a NOVES, and media types supported in each of access networks operated by the serving PLMN based on an access network which a UE can use in an IMS according to the third exemplary embodiment of the present disclosure.

A UE 810 accesses an EPC through one of a UTRAN, an E-UTRAN and a WiMAX (step 811). The UE 810 accessed the EPC establishes a connection with an ANDSF entity 820 (step 813).

After establishing the connection with the ANDSF entity 820, the UE 810 transmits an Access Network Info Request message to the ANDSF entity 820 (step 815). The Access Network Info Request message includes a UE Capabilities, a UE Location and a NOVES support.

After receiving the Access Network Info Request message from the UE 810, the ANDSF entity 820 detects the NOVES support included in the Access Network Info Request message and NOVES information depending on detecting the NOVES support. The ANDSF entity 820 transmits an Access Network Info Response message as a response message to the Access Network Info Request message to the UE 810 (step 817). The Access Network Info Response message includes an Available Access Network Info, a updated Inter-system Mobility Policies and a NOVES info. In FIG. 8, it will be assumed that access networks which the UE 810 can use at a current location are an LTE and a WLAN.

The NOVES info can be implemented in the form of a table such as an exemplary Table 2.

TABLE 2

| List | PLMN | Access Network | media | Media | Media |
|---|---|---|---|---|---|
| 1 | PLMN1 | LTE | Voice | Text | |
| 2 | PLMN1 | WLAN | Voice | Video | Text |
| 3 | PLMN2 | WLAN | Video | Text | |

In the Table 2, the NOVES info includes PLMN information indicating a ID(s) of a PLMN(s) which supports a NOVES, access network information indicating an access network(s) which supports the NOVES in the PLMN(s) supporting the NOVES, and media information indicating a media type(s) which the PLMN(s) and access network(s) support.

The NOVES info shown in the Table 2 is different from the NOVES info shown in the Table 1 in view of generating the NOVES info based on an access network which the UE 810 can use at a current location. That is, the NOVES info shown in the Table 1 includes a list related to a WLAN even though the UE 510 cannot use the WLAN at the current location, however the NOVES info shown in Table 2 is generated based on the access network which the UE 810 can use at the current location.

The NOVES info is generated based on the access network which the UE 810 can use, so an amount of resources necessary for transmitting the Access Network Info Response message becomes decreased thereby a signaling overhead becomes decreased.

After receiving the Access Network Info Response message from the ANDSF entity 820, the UE 810 determines an access network which the UE 810 can use based on parameters, specially the NOVES info, included in the Access Network Info Response message (819). Finally, the UE 810 can detect whether PLMNs support a NOVES, and media types supported in each of access networks operated by the PLMNs from the NOVES info included in the Access Network Info Response message.

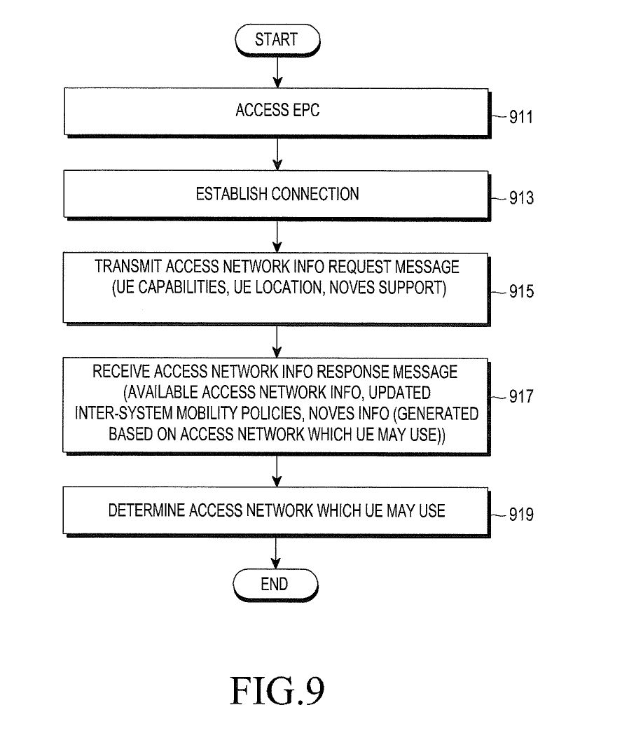

FIG. 9 is a flowchart schematically illustrating an operation of a UE 810 illustrated in FIG. 8.

A UE 810 accesses at step 911 an EPC through one of a UTRAN, an E-UTRAN and a WiMAX. The UE 810 establishes at step 913 a connection with an ANDSF entity 820. The UE 810 transmits at step 915 an Access Network Info Request message to the ANDSF entity 820. The Access Network Info Request message includes a UE Capabilities, a UE Location and a NOVES support.

The UE 810 receives at step 917 an Access Network Info Response message as a response message to the Access Network Info Request message from the ANDSF entity 820. The Access Network Info Response message includes an Available Access Network Info, a updated Inter-system Mobility Policies and a NOVES info. The NOVES info included in the Access Network Info Response message is generated based on an access network which the UE 810 can use.

The UE 810 determines at step 919 an access network which the UE 810 will use based on parameters, specially a NOVES info included in the Access Network Info Response message.

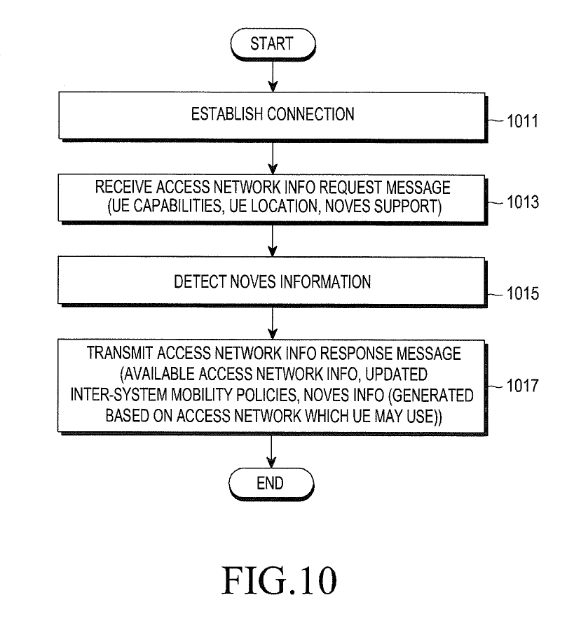

FIG. 10 is a flowchart schematically illustrating an operation of an ANDSF entity 820 illustrated at FIG. 8. An ANDSF entity 820 establishes at step 1011 a connection with a UE 810. The ANDSF entity 820 receives at step 1013 an Access Network Info Request message from the UE 810. The Access Network Info Request message includes a UE Capabilities, a UE Location and a NOVES support.

The ANDSF entity 820 detects in step 1015 NOVES information by detecting the NOVES support included in the Access Network Info Request message. The ANDSF entity 820 transmits at step 1017 an Access Network Info Response message as a response message to the Access Network Info Request message to the UE 810. The Access Network Info Response message includes an Available Access Network Info, a updated Inter-system Mobility Policies and a NOVES info. The NOVES info included in the Access Network Info Response message is generated based on an access network which the UE 810 can use.

In the third exemplary embodiment of the present disclosure, as described in FIGS. 8 to 10, a UE detects PLMNs which support a NOVES, and media types supported in each of access networks operated by the PLMNs based on an access network which a UE can use.

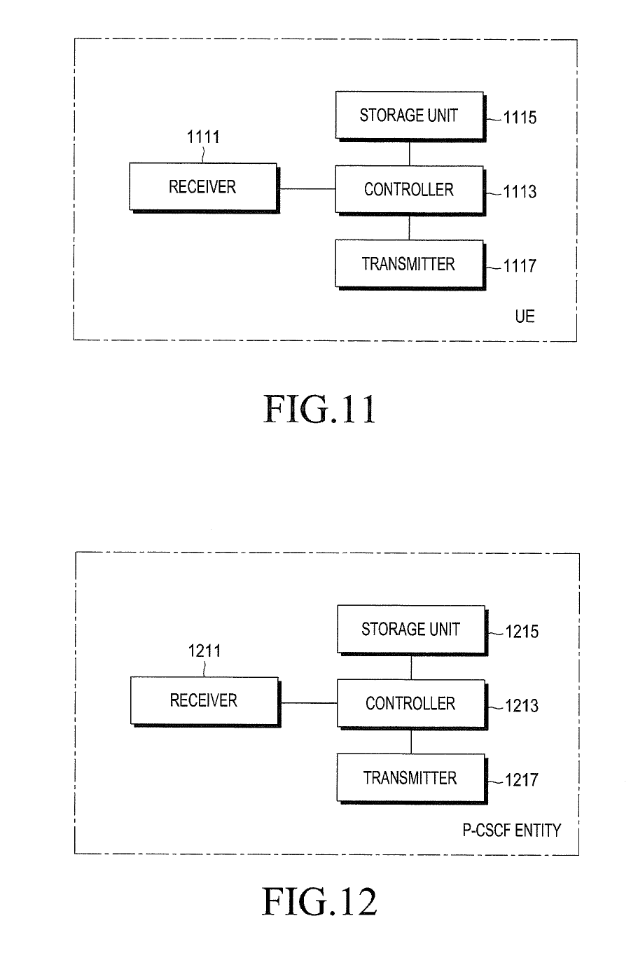

FIG. 11 is a block diagram schematically illustrating an internal structure of a UE in an IMS according to exemplary embodiments according to the present disclosure. A UE includes a receiver 1111, a controller 1113, a storage unit 1115 and a transmitter 1117. The controller 1113 controls the overall operation of the UE, specially controls the UE to perform an operating of detecting a PLMN(s) which supports a NOVES and media types supported in each of access networks operated by the PLMN(s). The operation of detecting the PLMN(s) which supports the NOVES and the media types supported in each of the access networks operated by the PLMN(s) is performed in the manner described before with reference to FIGS. 2, 3, 5, 6, 8 and 9, so the detailed description will be omitted herein. The receiver 1111 receives messages from a P-CSCF entity and an ANDSF entity under a control of the controller 1113. The storage unit 1115 stores the messages received by the receiver 1111 and data for an operation of the UE. The transmitter 1117 transmits messages to the P-CSCF entity and the ANDSF entity under the control of the controller 1113.

While the receiver 1111, the controller 1113, the storage unit 1115 and the transmitter 1117 are shown in FIG. 11 as separate units, it is to be understood that this is for merely convenience of description. In other words, the receiver 1111, the controller 1113, the storage unit 1115 and the transmitter 1117 can be incorporated into a single unit.

FIG. 12 is a block diagram schematically illustrating an internal structure of a P-CSCF entity in an IMS according to one embodiments of the present disclosure.

A P-CSCF entity includes a receiver 1211, a controller 1213, a storage unit 1215 and a transmitter 1217. The controller 1213 controls the overall operation of the P-CSCF entity, specially controls the P-CSCF entity to perform an operating of notifying a PLMN(s) which supports a NOVES, and media types supported in each of access networks operated by the PLMN(s). The operation of notifying the PLMN(s) which supports the NOVES, and the media types supported in each of the access networks operated by the PLMN(s) is perforated in the manner described before with reference to FIGS. 2 and 4, so the detailed description will be omitted herein.

The receiver 1211 receives messages from a UE under a control of the controller 1213. The storage unit 1215 stores the messages received by the receiver 1211 and data for an operation of the P-CSCF entity. The transmitter 1217 transmits messages to the UE under the control of the controller 1213.

While the receiver 1211, the controller 1213, the storage unit 1215 and the transmitter 1217 are shown in FIG. 12 as separate units, it is to be understood that this is for merely convenience of description. In other words, the receiver 1211, the controller 1213, the storage unit 1215 and the transmitter 1217 can be incorporated into a single unit.

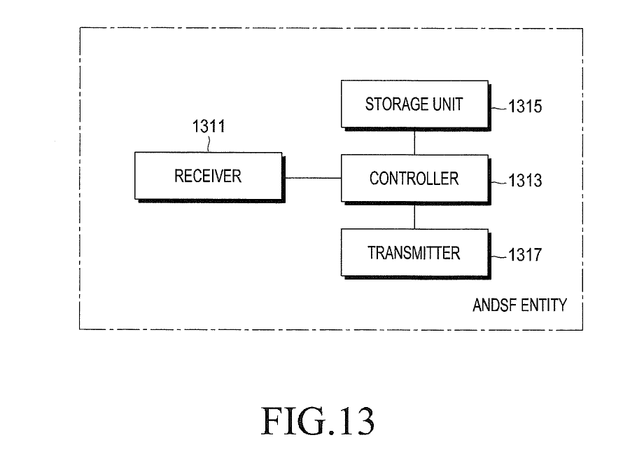

FIG. 13 is a block diagram schematically illustrating an internal structure of an ANDSF entity in an IMS according to one embodiment according to the present disclosure. An ANDSF entity includes a receiver 1311, a controller 1313, a storage unit 1315 and a transmitter 1317. The controller 1313 controls the overall operation of the ANDSF entity, specially controls the ANDSF entity to perform an operating of notifying a PLMN(s) which supports a NOVES, and media types supported in each of access networks operated by the PLMN(s). The operation of notifying the PLMN(s) which supports the NOVES, and the media types supported in each of the access networks operated by the PLMN(s) is performed in the manner described before with reference to FIGS. 5, 7, 8 and 10, so the detailed description will be omitted herein.

The receiver 1311 receives messages from a UE under a control of the controller 1313. The storage unit 1315 stores the messages received by the receiver 1311 and data for an operation of the ANDSF entity. The transmitter 1317 transmits messages to the UE under the control of the controller 1313.

While the receiver 1311, the controller 1313, the storage unit 1315 and transmitter 1317 are shown in FIG. 13 as separate units, it is to be understood that this is for merely convenience of description. In other words, the receiver 1311, the controller 1313, the storage unit 1315 and the transmitter 1317 can be incorporated into a single unit.

As is apparent from the foregoing description, exemplary embodiments of the present disclosure enable notifying a UE whether a PLMN supports a NOVES, and also notifying the UE of media types which each of access networks operated by the PLMN supports thereby the UE can receive a NOVES call which the UE wants to receive.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for making an emergency call at a User Equipment (UE), the method comprising the steps of:
transmitting a first message including a first information indicating, that the UE requests a Non Voice Emergency Service (NOVES) to a network entity; and
receiving a second message including a second information indicating at least one Public Land Mobile Network (PLMN) which supports the NOVES, and media types which at least one access network included in the at least one PLMN supports from the network entity.

2. The method as claimed in claim 1, wherein the at least one access network includes all access networks included in the at least one PLMN.

3. The method as claimed in claim 1, wherein the at least one access network includes an access network which the UE is able to use at a current location among all access networks included in the at least one PLMN.

4. The method as claimed in claim 1, wherein the network entity is a Proxy-Call Session Control Function (P-CSCF) entity, the first message is an INVITE message, and the second message is an Alternative services message.

5. The method as claimed in claim 1, wherein the first message is an Access Network Info Request message and the second message is an Access Network Info Response message if the network entity is an Access Network Discovery and Selection Function (ANDSF) entity.

6. A method for providing an emergency call at a network entity in a mobile communication system, the method comprising the steps of:
receiving a first message including a first information indicating that a User Equipment (UE) requests a Non Voice Emergency Service (NOVES) from the UE; and
transmitting a second message including a second information indicating at least one Public Land Mobile Network (PLMN) which supports the NOVES, and media types which at least one access network included in the at least one PLMN supports to the UE.

7. The method as claimed in claim 6, wherein the at least one access network includes all access networks included in the at least one PLMN.

8. The method as claimed in claim 6, wherein the at least one access network includes an access network which the UE is able to use at a current location among all access networks included in the at least one PLMN.

9. The method as claimed in claim 6, wherein the first message is an INVITE message and the second message is an Alternative services message if the network entity providing the emergency call is a Proxy-Call Session Control Function (P-CSCF) entity.

10. The method as claimed in claim 6, wherein the first message is an Access Network Info Request message and the second message is an Access Network Info Response message if the network entity providing the emergency call is an Access Network Discovery and Selection Function (ANDSF) entity.

11. A User Equipment (UE) in a mobile communication system, the UE comprising:
a transmitter for transmitting a first message including a first information indicating that the UE requests a Non Voice Emergency Service (NOVES) to a network entity; and
a receiver for receiving a second message including a second information indicating at least one Public Land Mobile Network (PLMN) which supports the NOVES, and media types which at least one access network included in the at least one PLMN supports from the network entity.

12. The UE as claimed in claim 11, wherein the at least one access network includes all access networks included in the at least one PLMN.

13. The UE as claimed in claim 11, wherein the at least one access network includes an access network which the UE is able to use at a current location among all access networks included in the at least one PLMN.

14. The UE as claimed in claim 11, wherein the network entity is a Proxy-Call Session Control Function (P-CSCF) entity, the first message is an INVITE message, and the second message is an Alternative services message.

15. The UE as claimed in claim 11, wherein the first message is an Access Network Info Request message and the second message is an Access Network Info Response message if the network entity is an Access Network Discovery and Selection Function (ANDSF) entity.

16. An emergency call provision entity in a mobile communication system, the emergency call provision entity comprising:
a receiver for receiving a first message including a first information indicating that a User Equipment (UE) requests a Non Voice Emergency Service (NOVES) from the UE; and
a transmitter for transmitting a second message including a second information indicating at least one Public Land Mobile Network (PLMN) which supports the NOVES, and media types which at least one access network included in the at least one PLMN supports to the UE.

17. The emergency call provision entity as claimed in claim 16, wherein the at least one access network includes all access networks included in the at least one PLMN.

18. The emergency call provision entity as claimed in claim 16, wherein the at least one access network includes an access network which the UE is able to use at a current location among all access networks included in the at least one PLMN.

19. The emergency call provision entity as claimed in claim 16, wherein the first message is an INVITE message and the second message is an Alternative services message if the emergency call provision entity is a Proxy-Call Session Control Function (P-CSCF) entity.

20. The emergency call provision entity as claimed in claim 16, wherein the first message is an Access Network Info Request message and the second message is an Access Network Info Response message if the emergency call provision entity is an Access Network Discovery and Selection Function (ANDSF) entity.
